(19) United States
(12) Patent Application Publication
(10) Pub. No.: US 2014/0000934 A1
(43) Pub. Date: Jan. 2, 2014

(54) ELECTRICAL CABLE

(71) Applicant: NEXANS, Paris (FR)

(72) Inventor: Per Bexell, Tranemo (SE)

(21) Appl. No.: 13/922,615

(22) Filed: Jun. 20, 2013

(30) Foreign Application Priority Data
Jul. 2, 2012 (SE) SE 1250748-9

(51) Int. Cl. H01B 9/00

(52) U.S. Cl. CPC H01B 9/006
USPC 174/115

(57) ABSTRACT

An electrical cable (100) is provided. The cable has an electrically insulating outer jacket (101), and a number of phase conductors (102) arranged within the outer jacket (101). The phase conductors (102) extend along the longitudinal extension of the cable (100), and the phase conductors (102) are individually provided with an outer electrically insulating sheath (104). The phase conductors (102) are arranged within the outer jacket (101) such that a central space (105) is formed between the phase conductors (102), and an earth conductor (106) is arranged in the central space. The earth conductor has electrically conducting twinned strands.

### RELATED APPLICATION

This application claims the benefit of priority from Swedish Patent Application No. 12 507 48-9, filed on Jul. 2, 2012, the entirety of which is incorporated by reference.

### TECHNICAL FIELD

The present invention relates to an electrical cable, and more particularly to a power cable. The electrical cable comprises a water proof and electrically insulating jacket, wherein four conductors and an earth are provided.

### BACKGROUND

Electrical power cables are well known, and generally comprise a plurality of conductors, each being electrically insulated by an electrically insulating plastic or rubber material. These are in turn arranged within a waterproof and electrically insulating jacket. The conductors are of aluminium, and each comprising a plurality of twinned aluminium strands, forming the conductor, which then in turn is covered by an insulating plastic or rubber material. These conductors extend along the longitudinal extension of the power cable, such that they may be connected at each end to transmit power along its length and longitudinal extension. The power cable also comprises an array of earth conductors, arranged around the periphery of the set of conductors, i.e. along the inside of the jacket.

Aluminium conductors are receptive to corrosion, should the jacket and the conductor insulating lining be damaged. If the conductor is a phase conductor, the current path is interrupted and the damage to the cable and the corrosion of the conductor will be noticeable through loss of current. If the damaged conductor however is a protective conductor, i.e. an earth conductor, the effected conductor will not at first be noticed. Only when the earth conductor is needed, such as during an insulation fault in the appliance connected to the cable, the damage to the cable will be discovered. Hence, the cable installation can be not electrically isolated, putting persons coming into contact with the installation in danger. Another problem is longitudinal displacement of the conductors within the jacket, which hampers self supporting characteristics of the power cable.

### SUMMARY

Accordingly, the present invention preferably seeks to mitigate, alleviate or eliminate one or more of the above-identified deficiencies in the art and disadvantages singly or in any combination and solves at least the above mentioned problems by providing an electrical cable having a longitudinal extension, comprising an electrically insulating outer jacket; a number of phase conductors arranged within the outer jacket, said phase conductors extending along the longitudinal extension of the cable, and said phase conductors individually being provided with an outer electrically insulating sheath, wherein said phase conductors are arranged within said outer jacket such that a central space is formed between the phase conductors; and an earth conductor, arranged in said central space, said earth conductor comprising electrically conducting twinned strands.

### BRIEF DESCRIPTION OF DRAWINGS

These and other aspects, features and advantages of which the invention is capable of will be apparent and elucidated from the following description of embodiments of the present invention, reference being made to the accompanying drawings, in which

FIG. 1 is a cross sectional view along a transversal plane of an electric cable according to one embodiment of the present invention.

### DETAILED DESCRIPTION

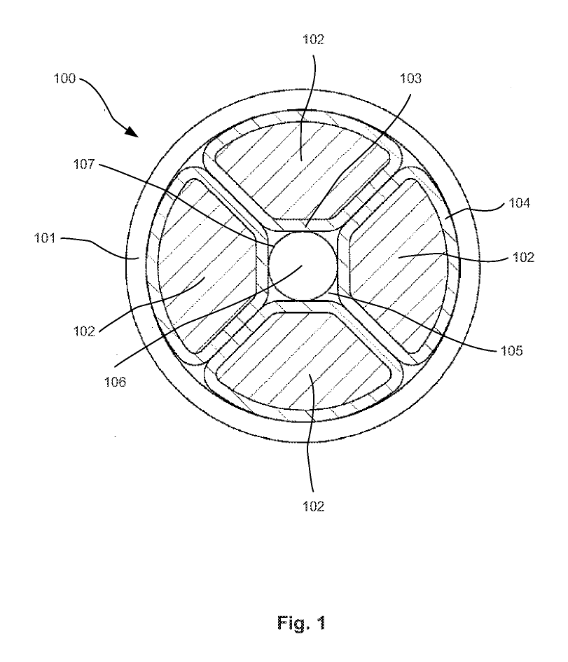

In FIG. 1 a cross sectional view along a transversal plane of an embodiment of an electric cable 100 according to the invention is disclosed. Thus, the electric cable 100 has a longitudinal extension. The electric cable 100 may be a power cable.

The electric cable 100 comprises an outer jacket 101. The outer jacket 101 is of a water proof and electrically insulating material, such as a polymeric or rubber material. The jacket 101 may for example be comprised of polyethylene, or other suitable material with low cold flow. The outer jacket 101 extends along the length of the electrical cable, such that the interior of the cable 100 can be shielded off from the surrounding environment.

The jacket 101 may be extruded onto four phase conductors 102 of a suitable extrudable and electrically insulating material, such that the four phase conductors 102 are arranged within the jacket 101. The four phase conductors 102 are sector shaped, with a blunted apex 103. The four phase conductors 102 each comprise a plurality of compressed and twined strands, and extend along the longitudinal extension of the electrical cable 100. The strands are of aluminum or copper. Peripherally of the compressed and twinned strands an insulating covering sheath 104 is arranged individually on each phase conductor 102. The sheath 104 is made of an electrically insulating plastic material.

The blunted apex 103 of the phase conductors 102 provides four phase conductor sides along the transversal plane of the cable 100; one side, being a circular arc side, facing outwardly towards the jacket 101; two sides, being radial sides, facing neighboring phase conductors; and one side, being a blunted apex side, facing a central space 105. Thus, the blunted apexes 103 of the four phase conductors 102 provide the central space 105. Within the central space an earth conductor 106 is arranged. The earth conductor 106 comprises a plurality of compressed and twined strands and extends along the longitudinal extension of the electrical cable 100. The strands are of aluminum or copper.

The arrangement of the earth conductor 106 centrally of the cable 100 provides a series of advantages. Firstly, the earth conductor 106 may be protected from damage by the peripherally arranged phase conductors 102. In this way, the phase conductors 102 will damaged before the earth conductor 106 upon damage of the cable 100. Hence, the damage to the cable 100 will be noticed by loss of current before the cable installation looses electrical isolation. Also, there is no need to collect the outer shield of earth conductors, according to the prior art, into one earth at the installation site. When the earth conductor 106 is centrally arranged, it is already collected in a way facilitating installation and avoiding complicated earth connection shoes etc.

The central earth conductor 106 may preferably be arranged without a peripheral insulating plastic material, such that the electrically conducting twinned strands of the earth conductor 106 contacts the sheath 104 of at least some of the phase conductors 102. In this way, the twinned strands of the earth conductor 106 will provide an outer peripheral corrugated interaction surface 107. The corrugated interaction surface 107 will be electrically insulated by the sheaths 104 of the phase conductors 102, while simultaneously increasing the interaction surface between the earth conductor 106 and the adjacent phase conductors 102, due to the corrugation thereof. This arrangement will improve the capability of the cable 100 to withstand longitudinal displacement of the conductors within the jacket, thus improving self supporting characteristics of the cable 100. Since the earth conductor 106 already is twinned, it is easier and safer to install than a concentric earth conductor where the individual strands are spread around the phase conductors. Also, since the earth conductor 106 is arranged without a peripheral insulating plastic material, the risk of injuries, due to stripping action of the earth conductor during installation, is decreased.

Interstices between the phase conductors 102 and earth conductor 106 may be provided with filler threads (not shown).

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

What is claimed is:

1. An electrical cable having a longitudinal extension, comprising:
an electrically insulating outer jacket;
a number of phase conductors arranged within the outer jacket, said phase conductors extending along the longitudinal extension of the cable, and said phase conductors individually being provided with an outer electrically insulating sheath, wherein said phase conductors are arranged within said outer jacket such that a central space is formed between the phase conductors; and
an earth conductor, arranged in said central space, said earth conductor comprising electrically conducting twinned strands.

2. The cable according to claim 1, wherein the phase conductors comprise twinned electrically conducting strands within the sheath.

3. The cable according to claim 1, wherein the electrically conducting twinned strands of the earth conductor contacts the sheath of at least some of the phase conductors.

4. The cable according to claim 1, wherein the number of phase conductors is three or four.

5. The cable according to claim 4, wherein the phase conductors are sector shaped with a blunted apex.

6. The cable according to claim 5, wherein the blunted apex of the phase conductors provides four phase conductor sides along the transversal plane of the cable.

7. The cable according to claim 6, wherein the four phase conductor sides comprises one side, being a circular arc side, facing outwardly towards the jacket; two sides, being radial sides, facing neighboring phase conductors; and one side, being a blunted apex side, facing the earth conductor.

8. The cable according to claim 1, wherein the phase conductors are made of copper or aluminum.

9. The cable according to claim 1, wherein the earth conductor is of copper or aluminum.

10. The cable according to claim 1, wherein the phase conductors is made of aluminum and the earth conductor is made of copper.

11. The cable according to claim 1, wherein the jacket is made of a polymeric or rubber material.
